(19) United States
(12) Patent Application Publication
(10) Pub. No.: US 2008/0082391 A1
(43) Pub. Date: Apr. 3, 2008

(54) SYSTEM AND METHOD FOR SCHEDULING HEALTHCARE WORKERS

(76) Inventor: Richard L. Gomez, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/537,862

(22) Filed: Oct. 2, 2006

(51) Int. Cl. G06F 15/02

(52) U.S. Cl. 705/9

(57) ABSTRACT

A system and method for scheduling healthcare workers that includes a healthcare worker database containing information obtained from healthcare worker registries, healthcare facility databases, instructions to search for available healthcare workers from the healthcare worker database to fill an open work shift of a healthcare facility based on the facility's preferences, instructions to display information relating to the healthcare workers available to fill the unfilled healthcare facility shift, an automated response system for automatically contacting an available healthcare worker or workers with details of the unfilled shift, and instructions to obtain a response from the available healthcare worker or workers either accepting or rejecting the unfilled shift.

### FIELD OF INVENTION

The present invention relates generally to a system and method for scheduling healthcare workers and in particular healthcare professionals including, but not limited to, such healthcare professionals as physicians, nurses, nurse practitioners, physical therapists, occupational therapists, medical technicians, pharmacists, and pharmacy technicians. The system and method for scheduling healthcare workers includes providing a healthcare worker database containing information obtained from healthcare worker registries, providing healthcare facility databases, searching for available healthcare workers from the healthcare worker database based on healthcare facility preferences, providing information relating to the healthcare workers available to fill an unfilled healthcare facility shift, utilizing an automated response system to contact an available healthcare worker with details of the unfilled shift, and obtaining a response from the available healthcare worker either accepting or rejecting the unfilled shift.

### BACKGROUND OF THE INVENTION

Nursing registries currently exist which provide nurses with an alternative to being employed by a single institution or entity. Nursing registries enable nurses to gain a great deal of flexibility in their work schedules and in the number of hours they want to work. Nursing registries certify the credentials and capabilities of nurses who register with them and then contract with hospitals and/or other healthcare facilities to use the nurses registered through them to fill any unfilled shifts of the hospitals and/or healthcare facilities that are created by illness, no shows, inadequate number of staff, etc.

In order to fill any unfilled shifts, the staff and administrators of hospitals and/or healthcare facilities make calls to the various nurse registries. The nurse registries then try to contact the nurses they have listed on their registries to try to fill the unfilled shift or shifts. As a result, several telephone calls go back and forth and several personnel are involved in order to fill an unfilled or open shift. The number of telephone calls and amount of time involved to fill open or unfilled shifts for other healthcare professionals, including those healthcare professionals for which there are no registries, is also significant.

In addition, the current nurse registries do not provide any way for hospitals or healthcare facilities to efficiently compare the rates that they will be charged for a particular nurse to fill a particular unfilled shift other than inquiring what the rate will be when they contact the registry indicating that they have an opening. The current nurse registries also fail to provide a flexible way for the nurses registered with them, as well as their contracting hospitals and/or healthcare facilities, to amend or change their informational data and/or preferences.

Accordingly, there is a need for a system and method for scheduling healthcare workers that is faster, more encompassing, more accurate, and more flexible than any of the existing scheduling methods, including the existing scheduling that utilizes nurse registries. There is also a need for a system and method for scheduling healthcare workers that creates an open market system with a free flow of information between healthcare facilities, healthcare worker registries, and healthcare workers.

### SUMMARY OF THE INVENTION

The invention is directed to a system and method for scheduling healthcare workers. The method for scheduling healthcare workers includes the steps of a) providing a healthcare worker database that includes a number of health care workers that are registered with at least one healthcare worker registry along with a schedule of availability and a contact phone number and/or electronic mail address for each of the healthcare workers, b) providing at least one healthcare facility database having a plurality of healthcare facilities wherein each healthcare facility has a preferred list of healthcare workers and/or a preferred list of healthcare worker registries, c) searching for registered healthcare workers that are available for working unfilled work shifts for a healthcare facility based upon the preferences of the healthcare facility, d) providing information relating to a predetermined number of available healthcare workers to fill an unfilled shift, e) utilizing an automated response system to contact one or more of the available healthcare workers with details of the unfilled shift, and e) obtaining a response from the available healthcare worker(s) either accepting or rejecting the unfilled shift. If an available healthcare worker rejects the unfilled shift, steps c through e may be repeated until an available healthcare worker accepts the unfilled shift.

In one exemplary embodiment of the method for scheduling healthcare workers, the step of utilizing an automated response system includes employing an automated voice response system that automatically calls the available healthcare worker's phone number and/or an automated text response system that automatically sends an e-mail or text message to the available healthcare worker's personal digital assistant or cellular phone. In another exemplary embodiment of the method for scheduling healthcare workers, information relating to at least three available healthcare workers is provided to the healthcare facility after searching for registered healthcare workers available to fill the healthcare facility's unfilled shift and a lock is put on the information, including the availability schedule, for those available healthcare workers until the healthcare facility selects one of the three available healthcare workers. In one aspect of the invention, the information relating to the available healthcare workers may include one or more of the healthcare worker's name, the name of the registry through which the healthcare worker is registered, and a rate that will be charged for the healthcare worker to fill the shift. Once the healthcare facility selects an available healthcare worker, the other two available healthcare workers are released. The selected available healthcare worker is then contacted as previously described amd the available healthcare worker either accepts or rejects the available shift. If the selected healthcare worker rejects the available shift, the healthcare facility is notified that the healthcare worker has rejected the shift and a prompt appears asking the healthcare facility if they would like to search again. If the healthcare facility chooses to search again, the same search parameters are reused without the need to reenter the search criteria.

The method of scheduling healthcare workers may also include the step of sending a confirmation to the search screen of a searching healthcare facility and/or to the healthcare worker registry through which a healthcare worker is registered when the shift has been accepted. The method may also include the step of updating the availability schedule of the healthcare worker who accepts an unfilled shift to show that they are no longer available for the time period that covers that shift.

The step of enabling a healthcare worker registered with one of the healthcare worker registries to update and/or add to their profile information may also be included in the method for scheduling healthcare workers. This profile information may include, but is not limited to, name, address, geographical region, contact information, acceptable hospitals, acceptable departments, and availability schedule. The method of the invention may also include the step of enabling healthcare facilities to pre-enter healthcare workers who they so not want to hire to fill shifts thereby deleting those healthcare workers from any search results.

The method of the invention may also include a billing step where the healthcare facility that fills an unfilled shift with an available healthcare worker is billed at the predetermined rate for that healthcare worker. A portion of the revenues collected from that bill may be paid to the healthcare worker registry through which the accepting healthcare worker was registered at the time the shift was accepted.

The invention is also directed to a web-based system for scheduling healthcare workers which includes a host server, a user interface for accessing the host server to access and input data, a processor for processing the inputted data, a memory coupled to the processor for storing the processed data and for storing instructions, and an automated response system coupled to the processor for automatically contacting available healthcare workers. The instructions stored in the memory include i) instructions for inputting information relating to a plurality of healthcare workers registered with at least one healthcare worker registry which includes a schedule of availability and a contact phone and/or e-mail address for each healthcare worker ii) instructions for accessing the information relating to the healthcare workers to determine if a healthcare worker is available for an unfilled work shift, iii) instructions for identifying a predetermined number of available healthcare workers to work the unfilled shift based on preferred search priorities, and iv) instructions for automatically contacting at least one of the predetermined number of available healthcare workers to fill the unfilled shift until a predetermined amount of time passes or until the contacted available healthcare worker accepts or rejects the unfilled shift.

The memory may further store instructions for repeating instructions ii) through iv) until the unfilled shift is filled. The memory of the web-based system comprises a number of databases for storing the processed data and the instructions including, but not limited to, a healthcare worker database which is comprised of information obtained from the healthcare worker registries and a healthcare facility database. The healthcare facility database includes at least a preferred list of healthcare workers and/or a preferred list of healthcare worker registries.

### BRIEF DESCRIPTION OF THE DRAWINGS

The figures illustrate various embodiments of the present invention by way of example, and not by way of limitation. Embodiments of the present invention may include part or all of the features shown in one of these figures, or may include features from two or more figures. Embodiments of the present invention may also include features described in the specification, or elements of features described in the specification.

Furthermore, embodiments of the present invention may include features that would be familiar to a person of ordinary skill in the art having studied this document. Thus, a more complete understanding of the present invention may be derived by referring to the detailed description and claims when considered in connection with the drawing figures where like reference numbers refer to similar elements throughout the figures, and

FIG. 1 is a schematic showing high level logical architecture for an exemplary embodiment of the system for scheduling healthcare workers;

FIG. 2 is block diagram showing an exemplary embodiment of a system for scheduling healthcare workers in accordance with the high level logical architecture shown in FIG. 1;

FIG. 3 is a block diagram showing another exemplary embodiment of a system for scheduling healthcare workers in accordance with the high level logical architecture shown in FIG. 1;

FIG. 4 is a flow chart depicting an exemplary method for scheduling healthcare workers in accordance with the present invention; and

FIGS. 5-13 show exemplary webpages/screen shots that may be generated to carry out the system and method for scheduling healthcare workers in accordance with the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: healthcare worker data such as name, address, geographical region, contact information, acceptable healthcare facilities, acceptable departments, and availability schedule, healthcare facility data such as preferred healthcare workers and preferred healthcare worker registries, healthcare worker registry data such as contracted healthcare facilities, registered healthcare workers, healthcare worker data, and rates charged for individual healthcare workers, file management data, financial management data, billing data and/or like data useful in the operation of the system. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or medical/business environment with access to a network. In an exemplary embodiment, access is through a network or the Internet through a commercially-available web-browser software package.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device, personal digital assistant (e.g., Palm Pilot@, Blackberry@), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system may frequently be described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITY) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, Image compression methods, etc.

In one exemplary embodiment, the ability to store a wide variety of information in different formats is facilitated by storing the information as a BLOB. Thus, any binary information can be stored in a storage space associated with a data set. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. Subsequent bytes of data may be used to indicate for example, the identity of the issuer or owner of the data, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, issuer or owner of data, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate. The data, including the header or trailer may be received by a stand alone interaction device configured to add, delete, modify, or augment the data in accordance with the header or trailer.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based and Packet Filtering among others. Firewall may be integrated within a web server or any other CMS components or may further reside as a separate entity.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, may be used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, XSLT, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perfonll the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, Co+, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “client”, “healthcare worker registry”, “healthcare facility”, “hospital” , or “business” may be used interchangeably with each other, and each shall mean any person, entity, machine, hardware, software or business. “Healthcare facility” as used herein means any healthcare related entity. Each participant is equipped with a computing device in order to interact with the system and facilitate online data access and data input. The customer has a computing unit in the form of a personal computer, although other types of computing units may be used including laptops, notebooks, hand held computers, set-top boxes, cellular telephones, touch-tone telephones and the like. The owner/operator of the system and method of the present invention has a computing unit implemented in the form of a computer-server, although other implementations are contemplated by the system including a computing center shown as a main frame computer, a mini-computer, a PC server, a network of computers located in the same of different geographic locations, or the like. Moreover, the system contemplates the use, sale or distribution of any goods, services or information over any network having similar functionality described herein.

In one exemplary embodiment, each client customer may be issued an “account” or “account number”. As used herein, the account or account number may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a charge card, credit card, debit card, prepaid card, embossed card, smart card, magnetic stripe card, bar code card, transponder, radio frequency card or an associated account. The system may include or interface with any of the foregoing cards or devices, or a fob having a transponder and RFID reader in RF communication with the fob. Although the system may include a fob embodiment, the invention is not to be so limited. Indeed, system may include any device having a transponder which is configured to communicate with RFID reader via RF communication. Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. The account number may be distributed and stored in any form of plastic, electronic, magnetic, radio frequency, wireless, audio and/or optical device capable of transmitting or downloading data from itself to a second device.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

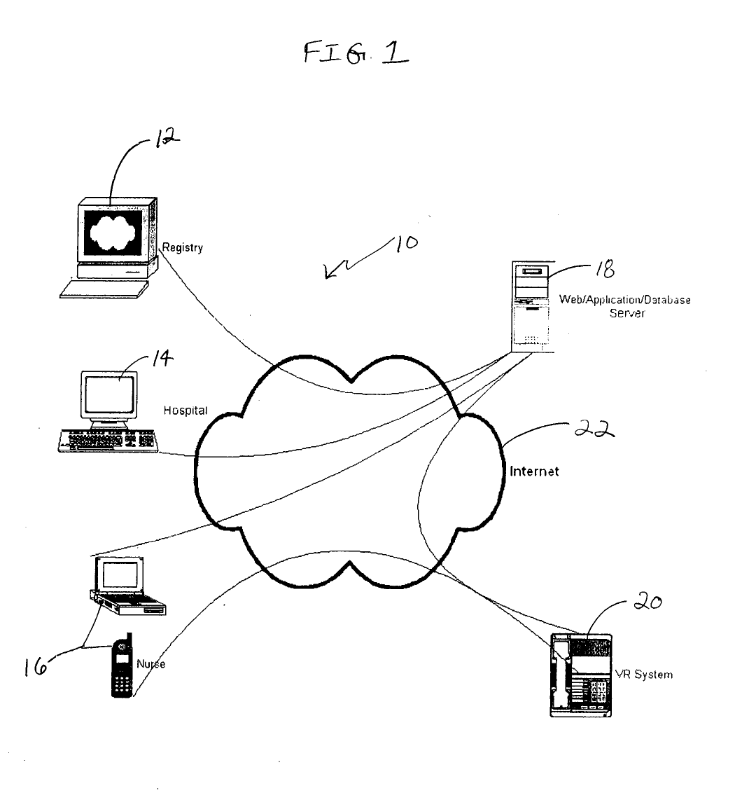

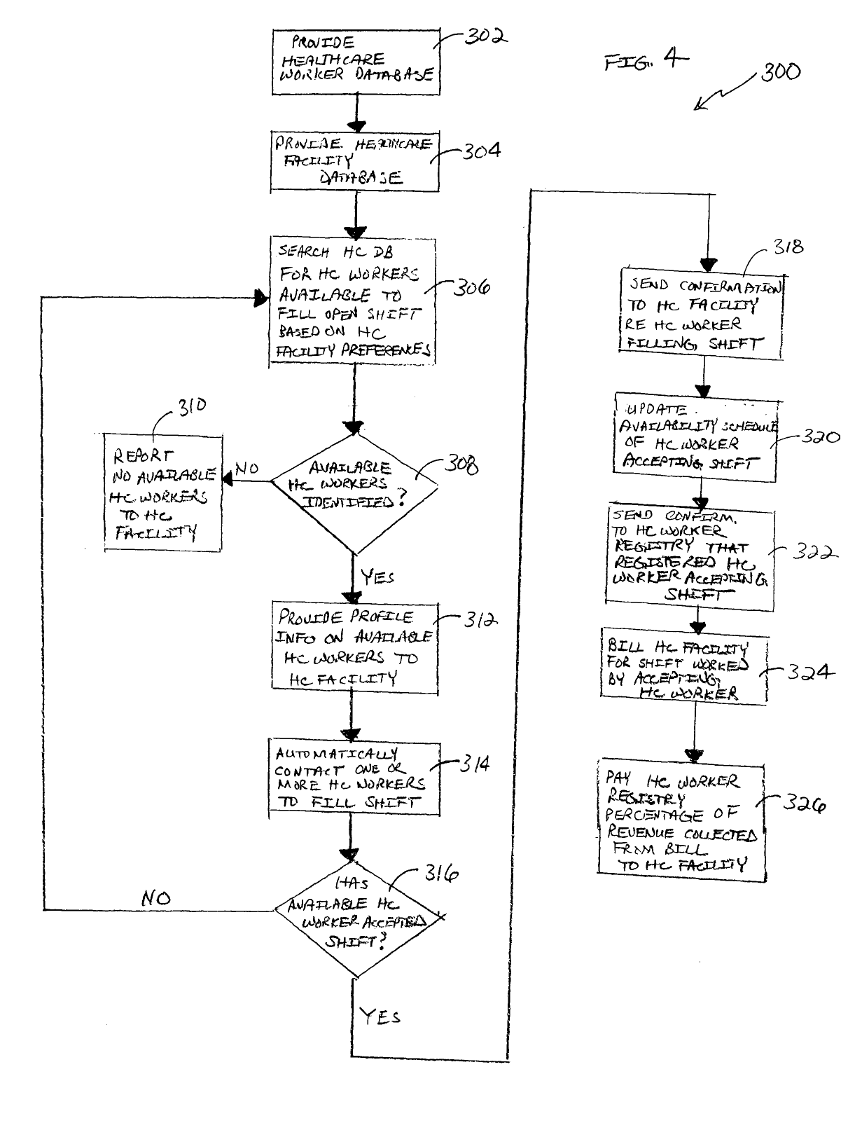

Referring now to FIGS. 4-13 the process flows and webpages/screenshots depicted are merely embodiments and are not intended to limit the scope of the invention as described herein. For example, the steps recited in any of the method or process descriptions may be executed in any order and are not limited to the order presented. It will be appreciated that the following description makes appropriate references not only to the steps and user interface elements depicted in FIGS. 4-13, but also to the various system components as described above with reference to FIGS. 1-3.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

FIG. 1 is a schematic showing high level logical architecture for an exemplary embodiment of the system 10 for scheduling healthcare workers. System 10 includes a healthcare worker registry interface 12, healthcare facility interface 14, a healthcare worker interface 16, a host server 18 which includes a web server, an application server, and a database server, an automated response system 20 coupled to the host server 18, and an interface with a wires or wireless communications network 22 (such as the Internet, for example).

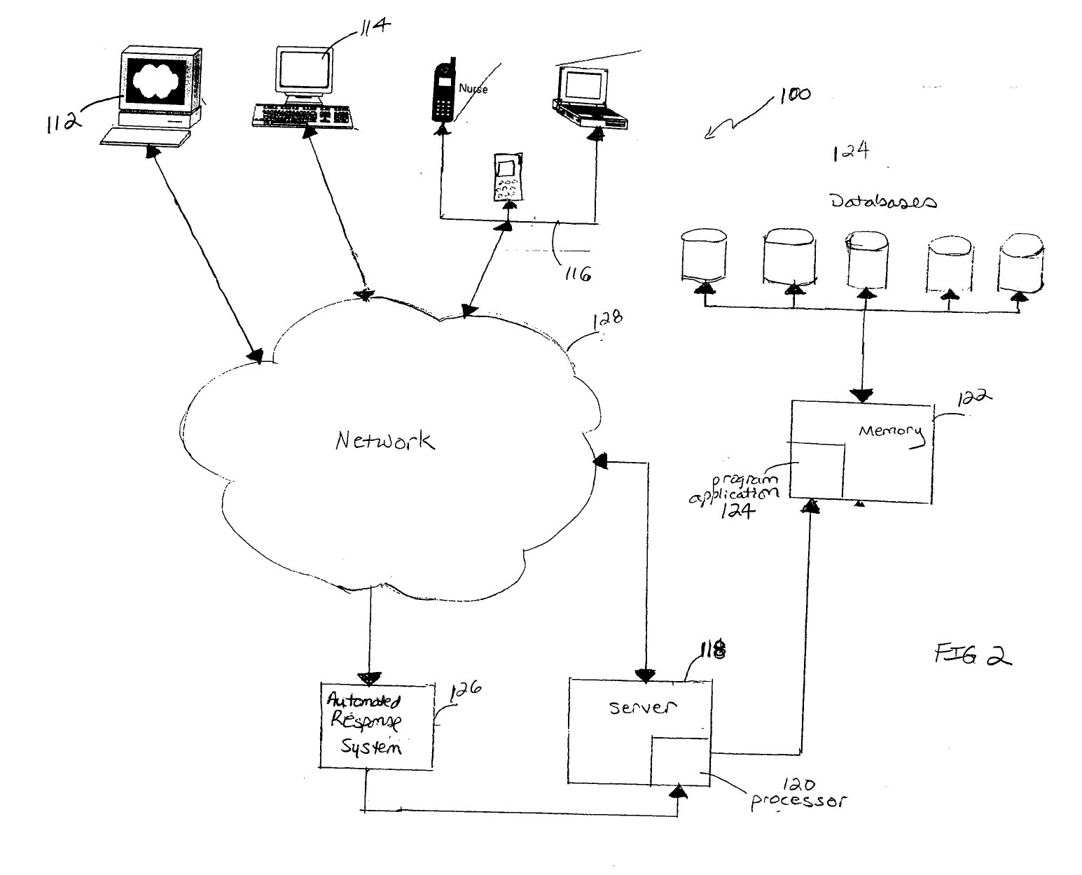

FIG. 2 is block diagram showing an exemplary embodiment of a system for scheduling healthcare workers in accordance with the high level logical architecture shown in FIG. 1. System 100 includes a healthcare worker registry interface 112, a healthcare facility interface 114, a healthcare worker interface 116, a host server 118, including a processor 120 for processing data, a memory 122 couples to the processor, an application program 124 stored in the memory 122 and accessible by the processor 120 for directing processing of the data by the processor 120, a plurality of databases 124, an automated response system 126 coupled to the host server 118, and an interface with a wired or wireless communications 128 network such as the Internet.

User interfaces for the healthcare worker registry and healthcare facility may include any input device and display for inputting data into system 100 and for displaying information derived from the data processed by the processor 120 such as, for example, a desktop computer, a laptop computer, a handheld device with internet access, and a cellular phone with internet access. The user interfaces for the healthcare worker registry and healthcare facility may also include a printer for printing the information derived from the data processed by the processor 120 such as available worker profile information and confirmation of accepting open shifts.

Databases 124 may include, but are not limited to, healthcare worker data such as name, address, geographical region, contact information, acceptable healthcare facilities, acceptable departments, and availability schedule, healthcare facility data such as preferred healthcare workers and preferred healthcare worker registries, healthcare worker registry data such as contracted healthcare facilities, registered healthcare workers, healthcare worker data, and rates charged for individual healthcare workers, file management data, financial management data, billing data and/or like data useful in the operation of the system.

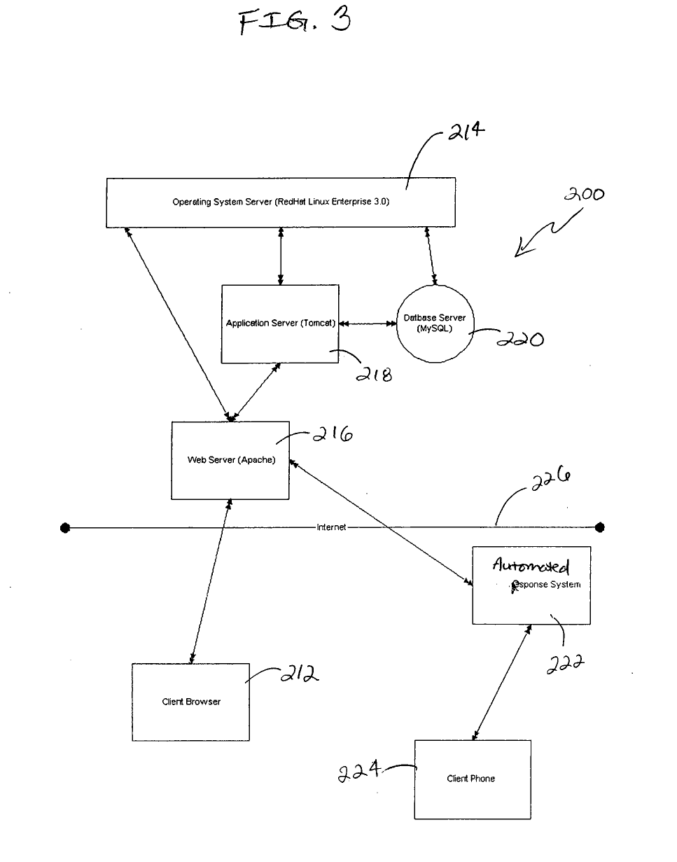

FIG. 3 is a block diagram showing another exemplary embodiment of a system 200 for scheduling healthcare workers in accordance with the high level logical architecture shown in FIG. 1. System 200 includes a client browser 212 which functions as a user interface for healthcare worker registries and healthcare facilities, an operating system server 214 (such as RedHat Linux Enterprise 3.0, for example), a web server 216 (such as Apache, for example), an application server 218 (such as Tomcat, for example), a database server 220 (such as MySQL, for example), an automated response system 222 for automatically contacting an available healthcare worker, a client or healthcare worker phone 224 which functions as a client or healthcare worker interface, and an interface with wired or wireless communications network 226 (such as the Internet, for example). The web server 216 is coupled to the operating system server 214 and the application server 218. The application server is coupled to the operating system server 214, the web server, 216, and the database server 220. The database server 220 is coupled to the operating system server 214 and the application server 218. The client browser or interface 212 accesses the web server 216 through the wireless communications network 226. The web server 216 accesses the automated response system 222 through the wireless communications network 226 which in turn accesses a client or healthcare worker by sending a call or communication to the client or healthcare worker's phone.

Various methods may be used in accordance with the system for scheduling healthcare workers. FIG. 4 shows a flowchart of an exemplary embodiment of a method 300 for scheduling healthcare workers. First, a healthcare worker database is provided in step 302 by contracting with healthcare worker registries and information from the healthcare worker registries is used to create the healthcare worker database. A database for healthcare facilities is provided in step 302 by contracting with healthcare facilities to aid in filling their open shifts with available healthcare workers. The database for healthcare facilities includes preferred healthcare workers and preferred healthcare worker registries for each healthcare facility. The healthcare worker database is searched in step 306 to find healthcare workers who are available to fill a healthcare facility's open shift based on the healthcare facility's preferences. A query is made in step 308 as to whether any available healthcare workers were identified to fill the open shift. If none were identified, a report is made to the searching healthcare facility in step 310 that no available healthcare workers were found to fill the shift. If available healthcare workers were identified in step 308, individual profile information on the available healthcare workers is provided to the healthcare facility with the open shift in step 312.

In step 314, the available healthcare worker or workers are automatically contacted to find out whether or not they will fill the open shift. The contacted available healthcare worker or workers then either accept or reject the open shift in step 316. If an available healthcare worker accepts the open shift in step 316, a confirmation is sent to the healthcare facility with the open shift in step 318 confirming that the accepting healthcare worker has agreed to fill the shift. In step 320, the availability schedule of the healthcare worker accepting the open shift is updated in the healthcare worker database to reflect that the healthcare worker is no longer available during the time period that covers the accepted shift. A confirmation is also sent to the healthcare worker registry that registered the available healthcare worker who accepted the open shift in step 322 so that the healthcare worker registry can keep accurate records as to the employment of its registered healthcare workers and obtain appropriate funds relating to the employment of that registered healthcare worker.

In step 324, the healthcare facility using the available healthcare worker to fill an open shift may be billed for the shift that was covered by the accepting healthcare worker. A portion or percentage of the revenues collected from that bill may then be paid to the healthcare worker registry who registered the healthcare worker who covered the shift in step 326.

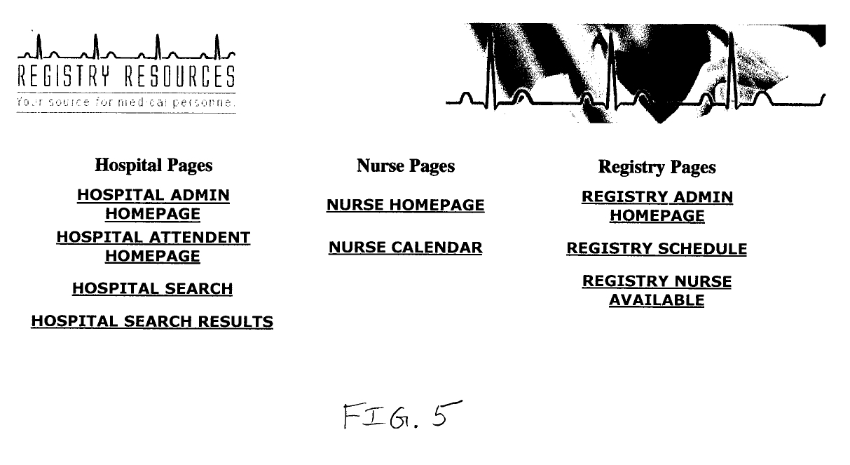

FIGS. 5-13 show exemplary webpages/screen shots that may be generated to carry out the system and method for scheduling healthcare workers in accordance with the present invention. FIG. 5 shows a web page that includes all of the pages and information available to the healthcare facilities (i.e. hospital in this case), healthcare workers (i.e. nurses in this case), and healthcare registries (registry). The pages and information available to the hospitals include a 1) hospital administration home page for hospital administrators for entering specific information by the hospital such as preferred workers, workers they do not want to schedule for shifts, preferred healthcare registries, etc., 2) a hospital attendant homepage for hospital employees to enter information on experiences or information relating to specific healthcare workers that have filled shifts at the hospital, 3) a hospital search page for entering search criteria for filling an unfilled shift, and 4) a hospital search results page which shows the results from the search. Nurses pages include a nurse homepage where a nurse can enter updated contact information, preference information such as preferred hospitals, schedule information such as when the nurse is not available for shifts, etc. and a nurse calendar page which shows the shifts scheduled for a nurse and locations of the shifts. The registry pages include 1) a registry administrative homepage where the registry can enter information and data on the nurses they have registered with them and where the registry can see the nurses registered with the registry, the rates that the registry charges for its nurses, and the hospitals it has contracts with to provide nurses, 2) a registry schedule which shows the nurses from the registry which have been booked for specific shifts, and 3) a registry nurse available page which shows the registry's nurses that are available for particular shifts.

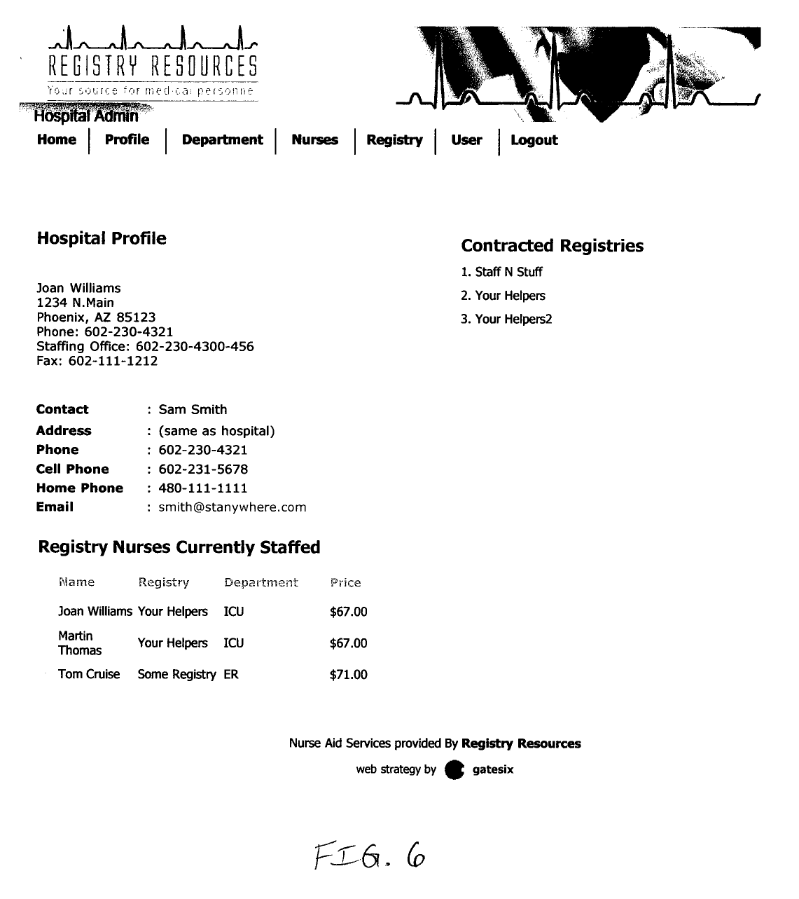

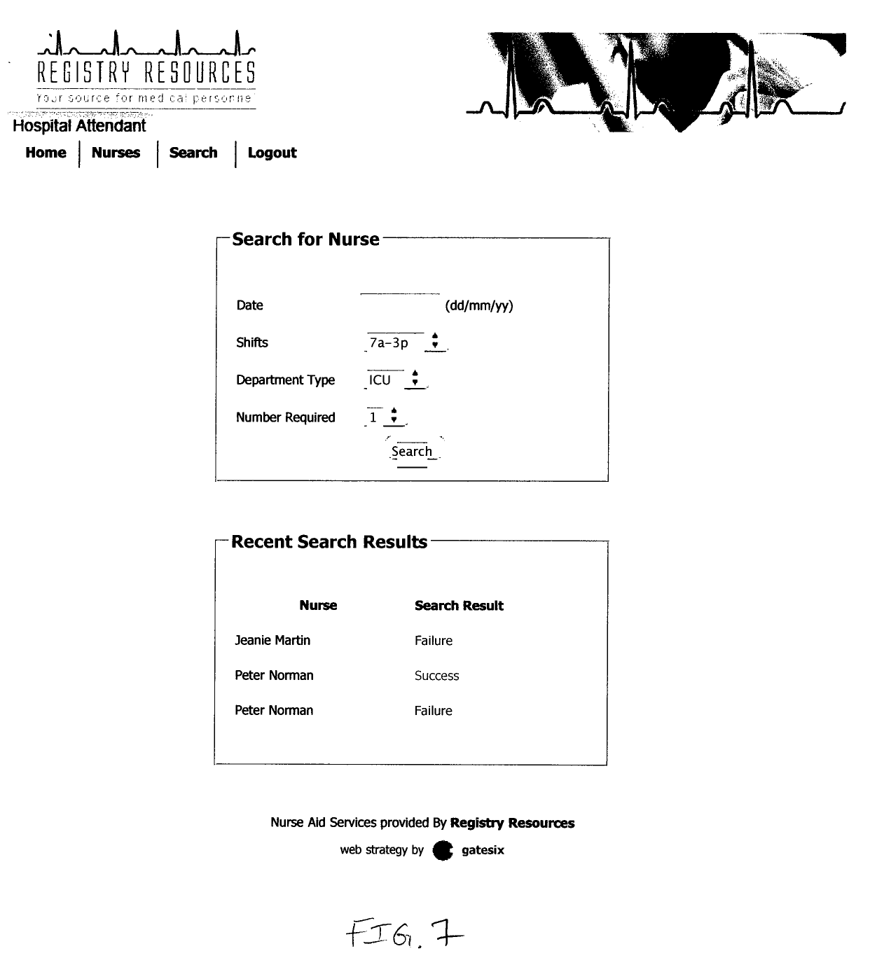

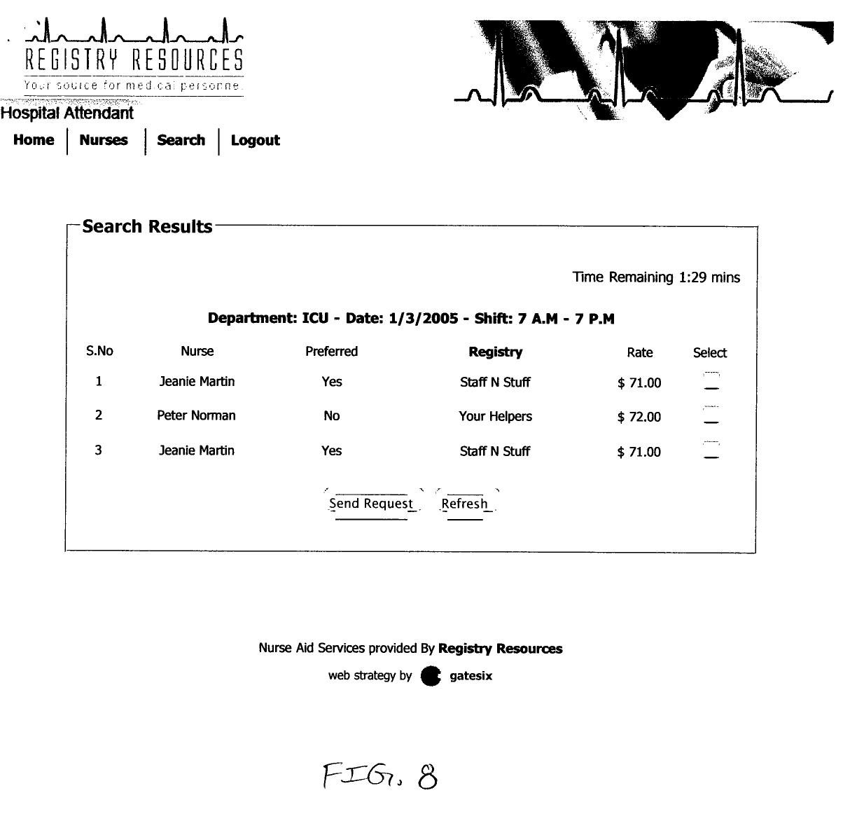

FIG. 6 is a webpage showing a hospital administrative homepage which shows the profile of the hospital which includes, among other items, a contact for the hospital, the registry nurses currently staffed with the hospital, and the registries that the hospital has contracted with. FIG. 7 is a webpage showing a hospital search request and the search results from a previous search. FIG. 8 is a webpage showing the search results from a search request which includes the names of the nurses available, whether they are a preferred nurse of the hospital, the registry with which the available nurses are registered, and the rate charged for the available nurses.

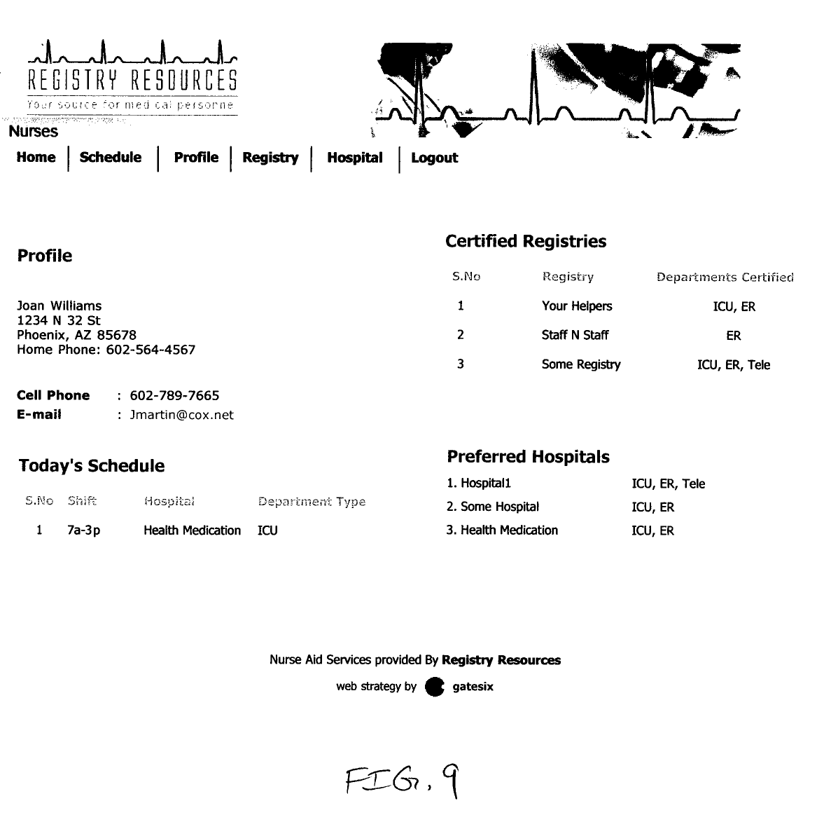

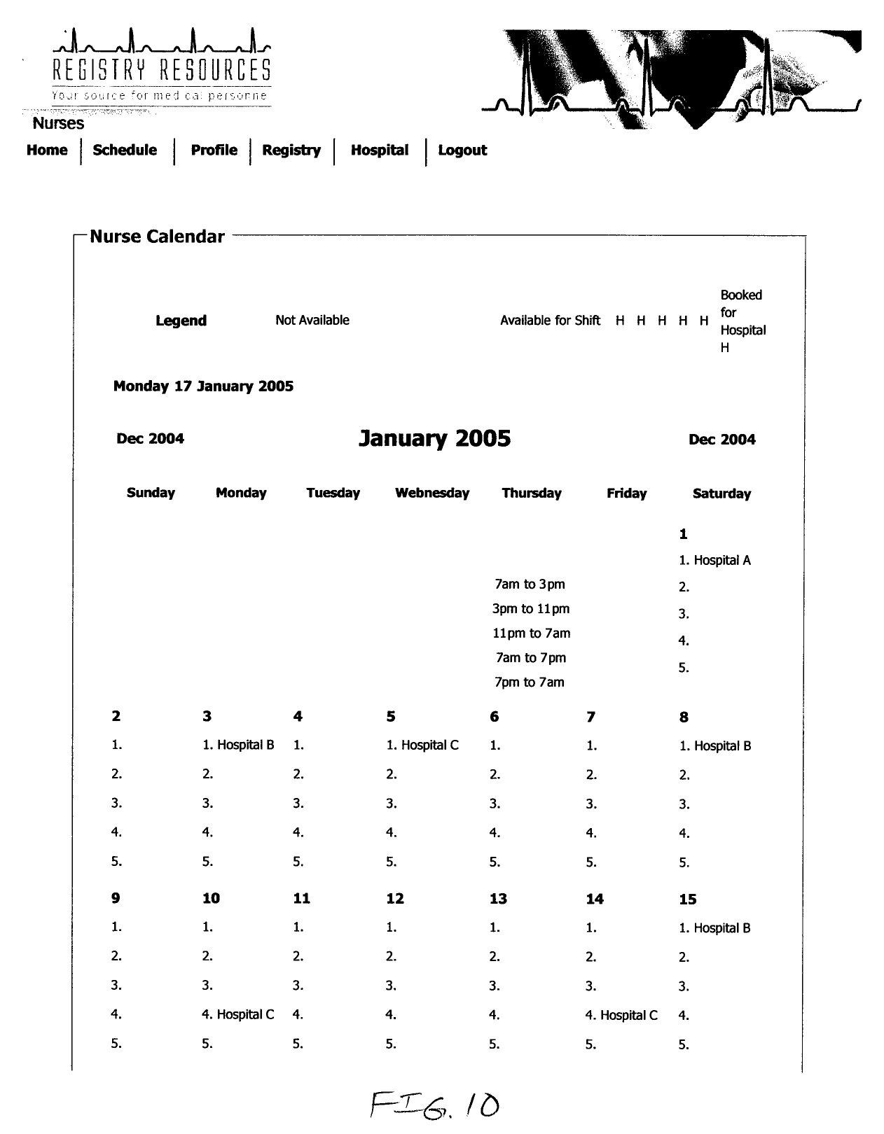

FIG. 9 is a webpage showing a nurse homepage which includes the nurse's contact information, the registries with which the nurse is registered, the hospitals that the nurse prefers, and the nurse's current schedule. FIG. 10 is a webpage showing a nurse's calendar page which shows the shifts scheduled for a particular nurse and the locations of the shifts.

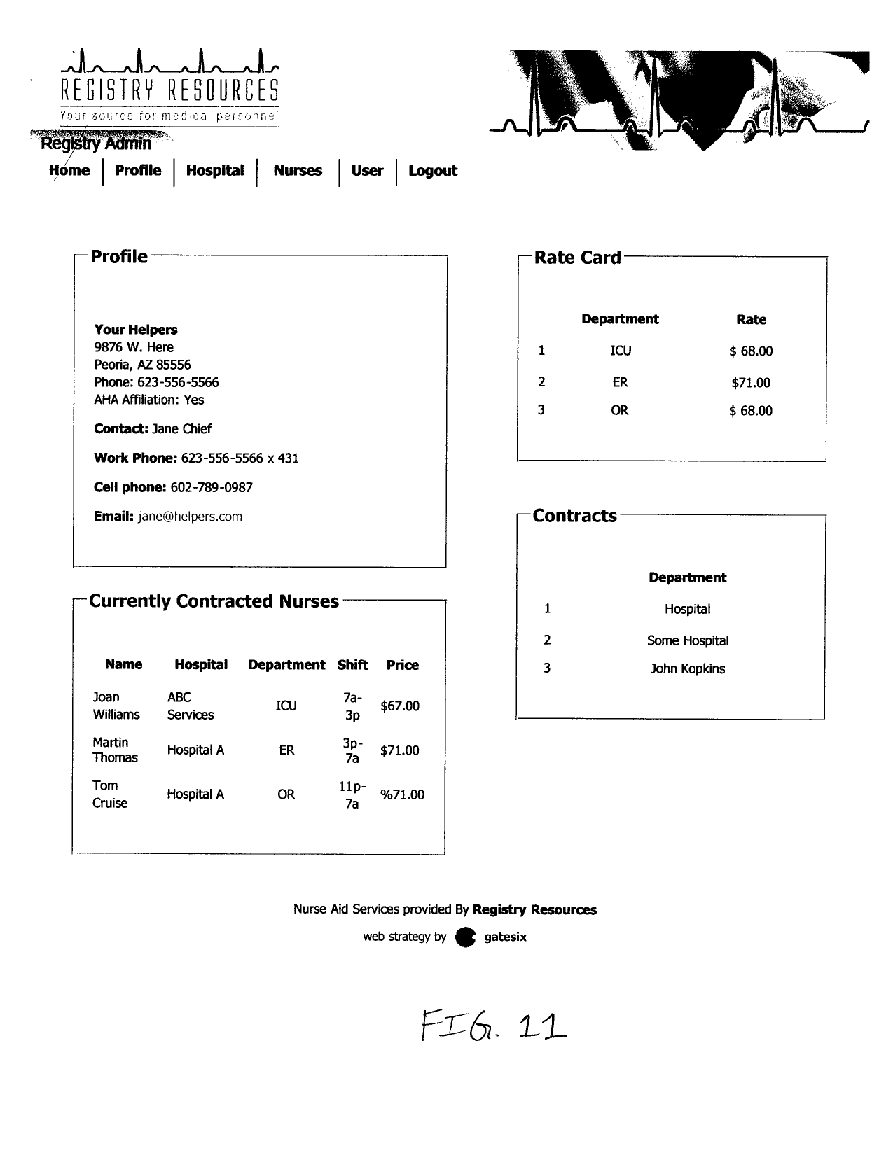

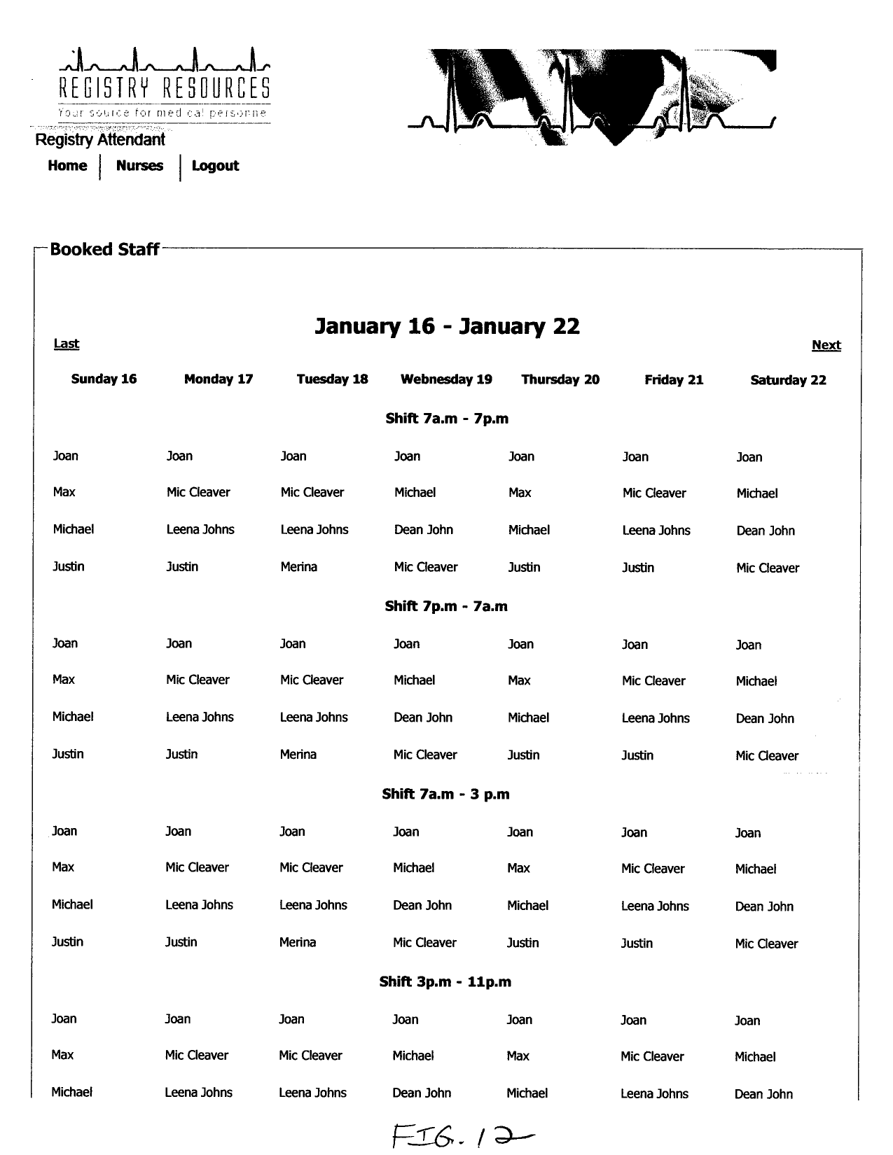

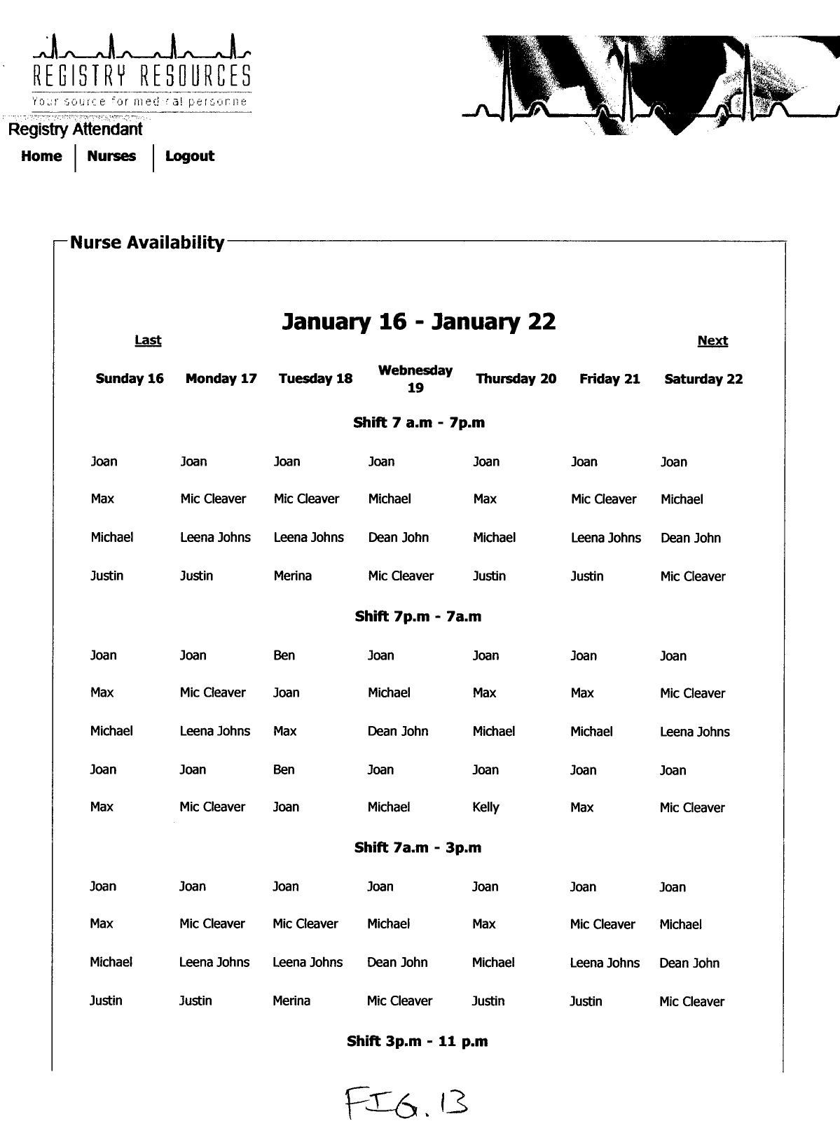

FIG. 11 is a webpage showing a registry administrative homepage which includes the name and address of the registry, the contact person for the registry, the hospitals that the registry has contracted with, the nurses that the registry has contracted with, and the rates that the registry charges for its nurses. FIG. 12 is a webpage showing a registry schedule which includes the dates, times, and names of the registry's nurses that have been schedules to fill shifts. FIG. 13 is a webpage showing a registry nurse available page which includes the names of nurses contracted with the registry and the dates and times that those nurses are available for shifts.

The foregoing description is of exemplary embodiments of the subject invention. It will be appreciated that the foregoing description is not intended to be limiting; rather, the exemplary embodiments set forth herein merely set forth some exemplary applications of the subject invention. It will be appreciated that various changes, deletions, and additions may be made to the components and steps discussed herein without departing from the scope of the invention as set forth in the appended claims.

1. A method for scheduling healthcare workers comprising the steps of:
a) providing a healthcare worker database having a plurality of healthcare workers registered with at least one healthcare worker registry along with a schedule of availability and at least one of a contact phone number and e-mail address for each of said healthcare workers;
b) providing at least one healthcare facility database having a plurality of healthcare facilities wherein each healthcare facility has at least one of a preferred list of healthcare workers and a preferred list of healthcare worker registries;
c) searching for registered healthcare workers that are available for working unfilled work shifts for a healthcare facility based on preferred search priorities of a given healthcare facility associated with said at least one healthcare facility database;
d) providing profile information relating to a predetermined number of healthcare workers that are available to fill an unfilled shift;
e) utilizing an automated response system to contact at least one of the available healthcare workers with details of the unfilled shift; and
f) obtaining a response from the at least one available healthcare worker either accepting or rejecting the unfilled shift.

2. The method of claim 1 wherein a response from the available healthcare worker rejecting the unfilled shift further comprises repeating steps c through f until an available healthcare worker accepts the unfilled shift.

3. The method of claim 1 wherein the step of utilizing an automated response system comprises the step of utilizing at least one of an automated voice response system which employs the contact phone number of the available healthcare worker and an automated text response system which employs at least one of a personal digital assistant and a cellular phone of the available healthcare worker.

4. The method of claim 1 wherein the step of providing profile information relating to a predetermined number of available healthcare workers comprises the step of providing profile information relating to at least three available healthcare workers.

5. The method of claim 1 wherein the step of providing profile information relating to a predetermined number of available healthcare workers further comprises the step of locking a selected available healthcare worker from being accessible in response to other search requests from healthcare facilities for a predetermined amount of time.

6. The method of claim 1 wherein the step of providing profile information relating to a predetermined number of available healthcare workers further comprises the step of providing any comments about the available healthcare workers that have been posted by a searching healthcare facility.

7. The method of claim 1 further comprising the step of sending a confirmation to a searching healthcare facility's search request screen when the available healthcare worker accepts the unfilled shift of the searching healthcare facility.

8. The method of claim 1 further comprising the step of sending a confirmation e-mail to the healthcare worker registry through which an accepting healthcare worker is registered when the available healthcare worker accepts the unfilled shift.

9. The method of claim 1 wherein the step of providing profile information relating to a predetermined number of available healthcare workers comprises providing at least one of a healthcare worker name, a registry name on which the healthcare worker is registered, and a rate that is charged for the healthcare worker for each available healthcare worker.

10. The method of claim 1 further comprising the step of enabling a healthcare worker registered with at least one of the healthcare worker registries to update and/or add to their profile information at least one of the following: name, address, geographical region, contact information, acceptable hospitals, acceptable healthcare facilities, and availability schedule.

11. The method of claim 9 wherein only healthcare facilities providing a healthcare facility database have access to rates charged for healthcare workers.

12. The method of claim 1 wherein said healthcare worker registry certifies credentials and capabilities of the healthcare workers.

13. The method of claim 12 wherein a healthcare worker may be associated with more than one healthcare worker registry.

14. The method of claim 1 further comprising the step of updating the availability schedule of an available healthcare worker who accepts an unfilled shift to show that the healthcare worker is unavailable during a time period that corresponds to the accepted unfilled shift.

15. The method of claim 1 further comprising the step of billing the healthcare facility that fills an unfilled shift with an available healthcare worker for the rate at which the healthcare worker is billed.

16. The method of claim 16 further comprising the step of paying a percentage of revenues collected from the bill to the healthcare facility to the healthcare worker registry through which the accepting healthcare worker was registered.

17. A web-based system for scheduling healthcare workers comprising:
a) a host server;
b) a user interface for accessing the host server to access and input data;
c) a processor for processing the inputted data;
d) a memory coupled to the processor for storing the processed data and for storing instructions for:
i. Inputting information relating to a plurality of healthcare workers registered with at least one healthcare worker registry which includes a schedule of availability and at least one of a contact phone number and an e-mail address for each of the plurality of healthcare workers;
ii. Accessing the information relating to the plurality of healthcare workers to determine if a healthcare worker is available for an unfilled work shift;
iii. Identifying a predetermined number of available healthcare workers to work the unfilled shift based on preferred search priorities; and
iv. Automatically contacting at least one of the predetermined number of available healthcare workers to fill the unfilled shift until a predetermined amount of time passes or until the contacted available healthcare worker accepts or rejects the unfilled shift;
e) an automated response system coupled to the processor for automatically contacting available healthcare workers.

18. The web-based system of claim 17 wherein the memory further stores instructions for repeating instructions ii through iv until the unfilled shift is filled.

19. The web-based system of claim 17 wherein the memory comprises a plurality of databases for storing the processed data and the instructions.

20. The web-based system of claim 19 wherein the plurality of databases include a healthcare worker database and a healthcare facility database.

21. The web-based system of claim 20 wherein the healthcare worker database includes a plurality of healthcare workers and information relating to each of the healthcare workers including a name for the healthcare worker, at least one of a phone number and e-mail address for the healthcare worker, an availability schedule for the healthcare worker, a name of the registry through which the healthcare worker is registered, and preferences of the healthcare worker.

22. The web-based system of claim 20 wherein the healthcare facility database includes at least one of a preferred list of health care workers and a preferred list of healthcare worker registries.

23. The web-based system of claim 17 wherein the memory further stores instructions for sending a confirmation to a searching healthcare facility's search request screen when the available healthcare worker accepts the unfilled shift of the searching healthcare facility.

24. The web-based system of claim 17 wherein the memory further stores instructions for sending a confirmation e-mail to the healthcare worker registry through which an accepting healthcare worker is registered when the available healthcare worker accepts the unfilled shift.

25. The web-based system of claim 17 wherein the memory further stores instructions for enabling a healthcare worker registered with at least one of the healthcare worker registries to update and/or add to their profile information at least one of the following: name, address, geographical region, contact information, acceptable healthcare facilities, acceptable departments, and availability schedule.

26. The web-based system of claim 17 wherein the memory further stores instructions for updating the availability schedule of an available healthcare worker who accepts an unfilled shift to show that the healthcare worker is unavailable during a time period that corresponds to the accepted unfilled shift.

27. The web-based system of claim 17 wherein the memory further stores instructions for billing the healthcare facility that fills an unfilled shift with an available healthcare worker for the rate at which the healthcare worker is billed.

28. The web-based system of claim 17 wherein the memory further stores instructions for paying a percentage of revenues collected from the bill to the healthcare facility to the healthcare worker registry through which the accepting healthcare worker was registered.
